(19) United States
(12) Patent Application Publication
(10) Pub. No.: US 2026/0015026 A1
(43) Pub. Date: Jan. 15, 2026

(54) Interactive Toddler Toy For Shopping Carts

(71) Applicant: Jessica Shingles, Karratha (AU)

(72) Inventor: Jessica Shingles, Karratha (AU)

(21) Appl. No.: 18/770,104

(22) Filed: Jul. 11, 2024

(51) Int. Cl. B62B 3/14

(52) U.S. Cl. CPC B62B 3/1456

(57) ABSTRACT

An interactive toddler toy generally comprises a plastic panel, mounting members, sensory accessories, and a battery power source and control unit. The plastic panel includes a front surface and a back surface. The mounting members are positioned on the back surface and designed to detachably mount the panel on a shopping cart handle. The sensory accessories are positioned on the front surface and designed to provide visual, audio, tactile, and mental stimulation to a toddler seated in a seat of a shopping cart. The battery power source and the control unit power and control operation of powered ones of the sensory accessories.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toddler toys and interactive displays for small children and more particularly pertains to a new interactive toddler toy for use with shopping carts or trolleys that have a toddler or child seat adjacent the handle of the shopping cart.

### (2) Description of Related Art Including Information Disclosed Under 37 CFR 1.97 and 1.98

The prior art relates to toddler toys and interactive displays for small children. The prior art, as best understood, does not disclose INVENTIONDIFFERENCE.

### BRIEF SUMMARY OF THE INVENTION

An embodiment of the disclosure meets the needs presented above in an interactive toddler toy generally comprising a plastic panel, mounting members, sensory accessories, and a battery power source and control unit. The plastic panel includes a front surface and a back surface. The mounting members are positioned on the back surface and designed to detachably mount the panel on a shopping cart handle. The sensory accessories are positioned on the front surface and designed to provide visual, audio, tactile, and mental stimulation to a toddler seated in a seat of a shopping cart. The battery power source and the control unit power and control operation of powered ones of the sensory accessories.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an interactive toddler toy according to an embodiment of the disclosure.

FIG. 2 is a front view of an embodiment of the disclosure.

FIG. 3 is a side view of an embodiment of the disclosure in use.

FIG. 4 is a back view of an embodiment of the disclosure.

FIG. 5 is a block diagram showing components of an embodiment of the disclosure.

### DETAILED DESCRIPTION OF THE INVENTION

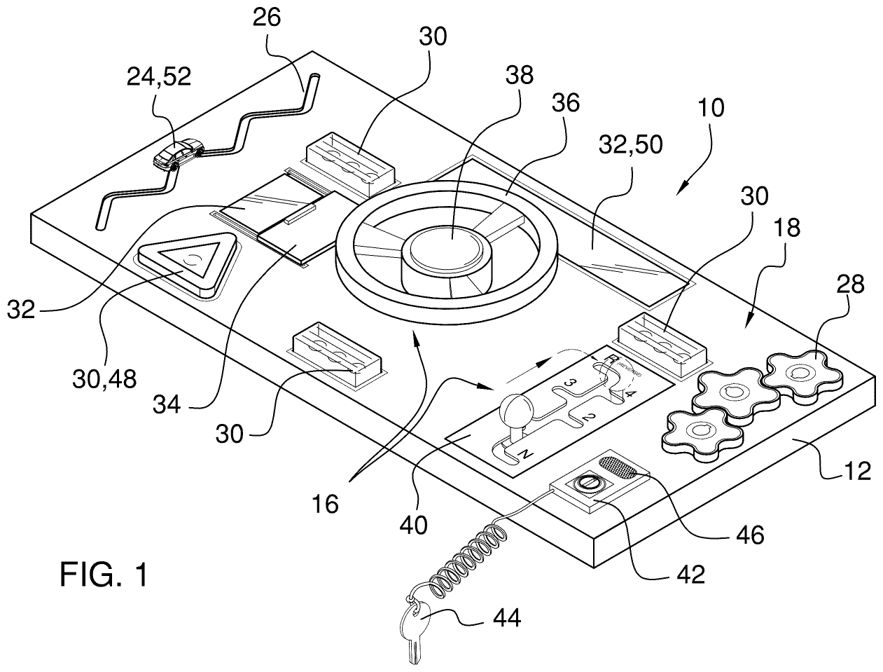

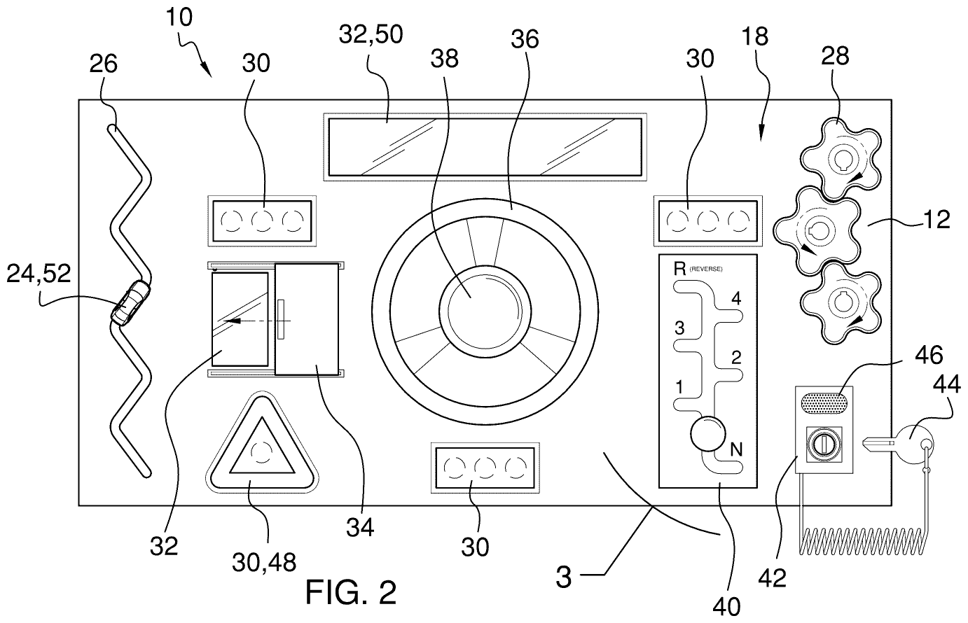

With reference now to the drawings, and in particular to FIGS. 1 through 5 thereof, a new interactive toddler toy embodying the principles and concepts of an embodiment of the disclosure and generally designated by the reference numeral 10 will be described.

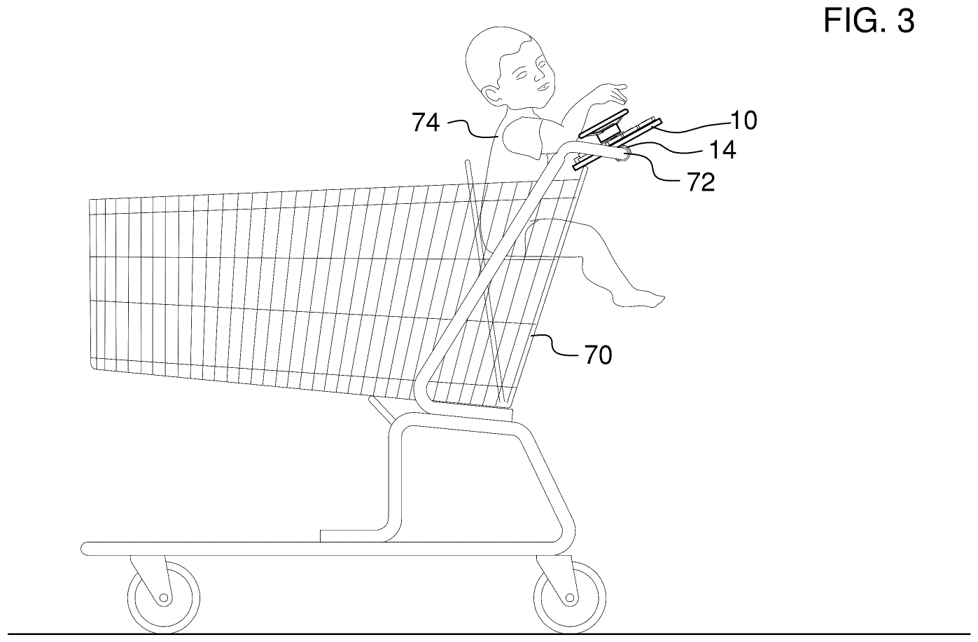

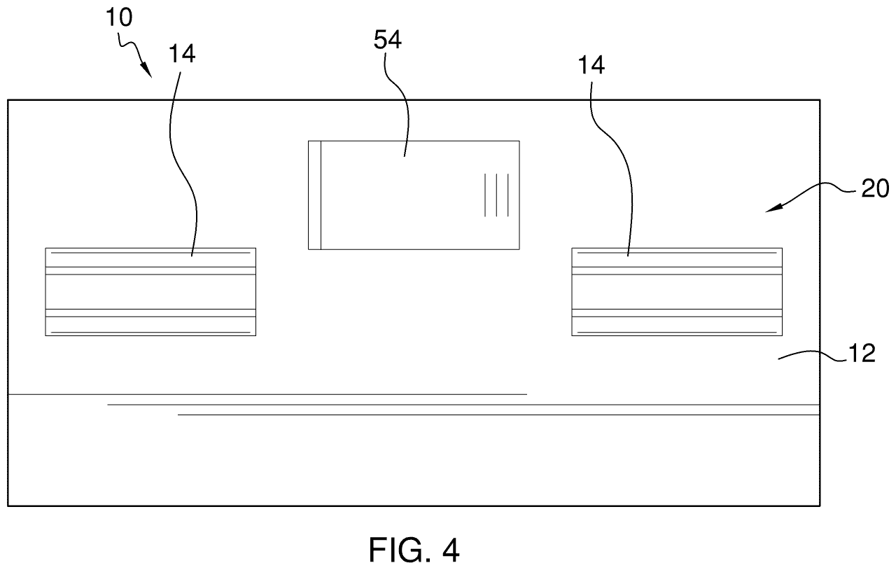

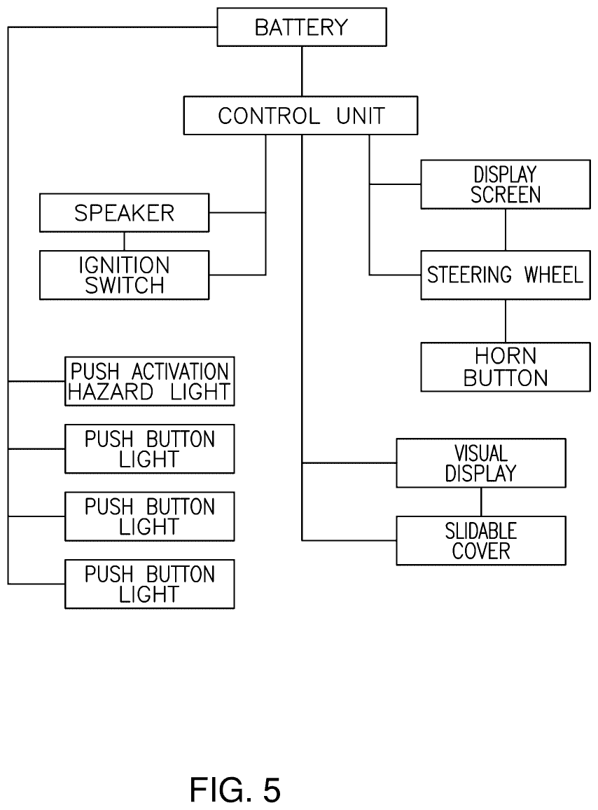

As best illustrated in FIGS. 1 through 5, the interactive toddler toy 10 generally comprises a plastic panel 12, mounting members 14, sensory accessories 16, and a battery power source and control unit, shown schematically in FIG. 5, which could be a microprocessor or similar. The plastic panel 12 includes a front surface 18 and a back surface 20. As shown in FIG. 3, the mounting members 14 are positioned on the back surface 20 and designed to detachably mount the panel 12 on a shopping cart handle 72. The sensory accessories 16 are positioned on the front surface 18 and designed to provide visual, audio, tactile, and mental stimulation to a toddler seated in a seat of a shopping cart 70. The battery power source and the control unit power and control operation of powered ones of the sensory accessories 16, as shown in FIG. 5. As seen in FIG. 4, a battery cover 54 covers where the battery is housed.

As shown in FIGS. 3 and 4, the mounting members 14 are designed as resilient C-shaped clamps that detachably connect to a shopping cart handle 72 in a snap-fit connection, as shown in FIG. 3. In at least one possible embodiment, the mounting members 14 alternatively could be clasps or clamps and include movable jaws that are spring-loaded or made of resilient elastic. The mounting members 14 could also include a layer of gripping material 22 positioned on an inner surface of the mounting members 14. Any type of frictional material, as a layer or individual bodies, could be utilized to further increase the gripping force on the shopping cart handle 72 to hold the panel 12 in place. It should be noted that the panel 12 may be shorter in width than the width of the handle 72 of the shopping cart 70 to provide a place for the user, such as the parent or caregiver of the toddler in the seat of the shopping cart 70, to grasp the handle 72.

The sensory accessories 16 could be a combination of a variety of types of devices, and examples are shown in the figures, though the possible designs and arrangement of the sensory accessories 16 are not limited by the exemplary embodiment shown in the figures. The sensory accessories 16 include manually slidable or rotatable components, such as an object 24 slidably mounted in a zig zag or curved track 26 in the panel 12 and meshed rotatable gear-shaped objects 28. The sensory accessories 16 also can include pressable buttons 30 that emit lights, sound, or a combination thereof. The sensory accessories 16 can further include visual displays 32. At least one of the visual displays 32 can be in the form of a static image. At least one of the visual displays 32 can be in the form of an electronic screen designed to show changing images. At least one of the visual displays 32 can include a slidable cover 34 to cover and uncover the visual display 32.

In the exemplary embodiment shown in the figures, the sensory accessories 16 are designed to present an automotive theme. The automotive-themed sensory accessories 16 can include one or more of the following: a rotatable steering wheel 36 with a horn button 38, a gear shift knob assembly 40, an ignition switch 42 and corresponding insertable key 44 that includes a speaker 46 to emit a motor sound when the key is inserted and turned, pressable buttons 30 showing different traffic colors including red, yellow, green, and blue and automotive dashboard symbols including a hazard light 48, and a display screen 50 designed to show different scenery or driving-related images and video, a toy car 52 slidably mounted in a zig zag or curved track 26, and a plurality of meshed rotatable gears 28.

In use as shown in FIG. 3, the user detachably connects the interactive toddler toy 10 to the shopping cart 70 by pressing the mounting members 14 onto a handle 72 of the shopping cart 70. The toddler 74, which is a child generally in the age range of about 18-24 months, or possibly 12-36 months, can then play with the various sensory accessories 16. The sensory accessories 16 are designed for entertainment to make a shopping experience more pleasant for toddlers and parents, but also for education to teach a child and encourage interaction with parents and caregivers.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An interactive toddler toy for shopping carts comprising:
a plastic panel comprising a front surface and a back surface;
mounting members disposed on said back surface and configured to detachably mount said panel on a shopping cart handle;
sensory accessories disposed on said front surface and configured to provide visual, audio, tactile, and mental stimulation to a toddler seated in a seat of a shopping cart; and
a battery power source and control unit to power and control operation of powered ones of said sensory accessories.

2. The interactive toddler toy for shopping carts of claim 1, wherein said mounting members comprise resilient C-shaped clamps that detachably connect to a shopping cart handle in a snap-fit connection.

3. The interactive toddler toy for shopping carts of claim 1, wherein said mounting members comprise a layer of gripping material disposed on an inner surface of said mounting members.

4. The interactive toddler toy for shopping carts of claim 1, wherein said sensory accessories comprise manually slidable or rotatable components.

5. The interactive toddler toy for shopping carts of claim 4, wherein said manually slidable and rotatable components comprise objects slidably mounted in a zig zag or curved track in said panel and meshed rotatable gear-shaped objects.

6. The interactive toddler toy for shopping carts of claim 1, wherein said sensory accessories comprise pressable buttons that emit lights, sound, or a combination thereof.

7. The interactive toddler toy for shopping carts of claim 1, wherein said sensory accessories comprise visual displays.

8. The interactive toddler toy for shopping carts of claim 7, wherein at least one of said visual displays comprises a static image.

9. The interactive toddler toy for shopping carts of claim 7, wherein at least one of said visual displays comprises an electronic screen configured to show changing images.

10. The interactive toddler toy for shopping carts of claim 1, wherein at least one of said visual displays comprises a slidable cover to cover and uncover said visual display.

11. The interactive toddler toy for shopping carts of claim 1, wherein said sensory accessories are designed to present an automotive theme.

12. The interactive toddler toy for shopping carts of claim 11, wherein said sensory accessories comprise a rotatable steering wheel with a horn button.

13. The interactive toddler toy for shopping carts of claim 11, wherein said sensory accessories comprise a gear shift knob assembly.

14. The interactive toddler toy for shopping carts of claim 11, wherein said sensory accessories comprise an ignition switch and corresponding insertable key, wherein said ignition switch comprises a speaker to emit a motor sound when the key is inserted and turned.

15. The interactive toddler toy for shopping carts of claim 11, wherein said sensory accessories comprise pressable buttons showing different traffic colors including red, yellow, green, and blue and automotive dashboard symbols including a hazard light.

16. The interactive toddler toy for shopping carts of claim 11, wherein said sensory accessories comprise a display screen configured to show different scenery or driving-related images and video.

17. The interactive toddler toy for shopping carts of claim 11, wherein said sensory accessories comprise a toy car slidably mounted in a zig zag or curved track.

18. The interactive toddler toy for shopping carts of claim 11, wherein said sensory accessories comprise a plurality of meshed rotatable gears.

19. The interactive toddler toy for shopping carts of claim 11, wherein said sensory accessories comprise:
a rotatable steering wheel with a horn button,
a gear shift knob assembly,
an ignition switch and corresponding insertable key, wherein said ignition switch comprises a speaker to emit a motor sound when the key is inserted and turned,
pressable buttons showing different traffic colors including red, yellow, green, and blue and automotive dashboard symbols including a hazard light,
a display screen configured to show different scenery or driving-related images and video,
a toy car slidably mounted in a zig zag or curved track, and
a plurality of meshed rotatable gears.

20. An interactive toddler toy for shopping carts comprising:
a plastic panel comprising a front surface and a back surface;
mounting members disposed on said back surface and configured to detachably mount said panel on a shopping cart handle, wherein:
said mounting members comprise resilient C-shaped clamps that detachably connect to a shopping cart handle in a snap-fit connection,
said mounting members comprise a layer of gripping material disposed on an inner surface of said mounting members;
sensory accessories disposed on said front surface and configured to provide visual, audio, tactile, and mental stimulation to a toddler seated in a seat of a shopping cart, wherein:
said sensory accessories comprise manually slidable or rotatable components, said manually slidable and rotatable components comprise objects slidably mounted in a zig zag or curved track in said panel and meshed rotatable gear-shaped objects,
said sensory accessories comprise pressable buttons that emit lights, sound, or a combination thereof,
said sensory accessories comprise visual displays, at least one of said visual displays comprises a static image, at least one of said visual displays comprises an electronic screen configured to show changing images, at least one of said visual displays comprises a slidable cover to cover and uncover said visual display, and
said sensory accessories are designed to present an automotive theme, wherein said sensory accessories comprise:
a rotatable steering wheel with a horn button,
a gear shift knob assembly,
an ignition switch and corresponding insertable key, wherein said ignition switch comprises a speaker to emit a motor sound when the key is inserted and turned,
pressable buttons showing different traffic colors including red, yellow, green, and blue and automotive dashboard symbols including a hazard light,
a display screen configured to show different scenery or driving-related images and video, said display screen comprises a slidable cover to cover and uncover said display screen,
a toy car slidably mounted in a zig zag or curved track, and
a plurality of meshed rotatable gears; and
a battery power source and control unit to power and control operation of powered ones of said sensory accessories.
